(19) United States
(12) Patent Application Publication
(10) Pub. No.: US 2004/0109698 A1
(43) Pub. Date: Jun. 10, 2004

(54) Optical CRZ transmitter using Mach-Zehnder modulator

(76) Inventors: Sung-Kee Kim, Seoul (KR); Seong-Taek Hwang, Pyongtaek-shi (KR)

Correspondence Address: CHA & REITER, LLC, 210 ROUTE 4 EAST STE 103, PARAMUS, NJ, 07652, US

(21) Appl. No.: 10/458,656

(22) Filed: Jun. 10, 2003

(30) Foreign Application Priority Data
Dec. 10, 2002 (KR) 2002-78248

(51) Int. Cl. H04B 10/04

(52) U.S. Cl. 398/199; 398/183

(57) ABSTRACT

An optical CRZ transmitter using a Mach-Zehnder (MZ) modulator is provided which enables a simple construction process and has reduced production cost. The optical CRZ transmitter includes a logic operation unit for performing a logic operation between a received NRZ (Non Return-to-Zero) data signal and clock signal data signal and a clock signal, and generating electric RZ (Return-to-Zero) data; an amplifier to amplify the electric RZ data; and a MZ modulation unit to modulate the amplified electric RZ data into an optical signal, and impose a chirp signal on the optical signal by varying an input voltage of the amplified electric RZ data.

### CLAIM OF PRIORITY

This application claims priority to an application entitled “OPTICAL CRZ TRANSMITTER USING MACH-ZEHNDER MODULATOR”, filed in the Korean Intellectual Property Office on Dec. 10, 2002 and assigned Serial No. 2002-78248, the contents of which are hereby incorporated by reference.

### BACKGROUND OF THE INVENTION

1. Field of the Invention

The present invention relates to an optical Chirped Return-to-Zero (CRZ) transmitter using a Mach-Zehnder modulator, and more particularly to an optical CRZ transmitter for converting Non-Return to Zero (NRZ) data to optical Return-to-Zero (RZ) data, and imposing a chirp signal on the converted optical RZ data to create a new modulation signal.

2. Description of the Related Art

Typically, an optical RZ signal is weakened by dispersion while being transmitted via optical fibers because it has a pulse width less than an NRZ signal. On the contrary, the optical RZ signal is very resistant to a nonlinear phenomenon such as a Self Phase Modulation (SPM). Since the RZ signal has a pulse width less than the NRZ signal, it has a higher peak power even though the same power is applied to both the RZ and NRZ signals. As a result, the RZ signal has signal reception sensitivity better than the NRZ signal. However, the RZ signal has a wider spectrum than the NRZ signal such that it is more easily dispersed than the NRZ signal.

While a linear phenomenon such as dispersion is easily compensated by a dispersion compensation optical fiber, a nonlinear phenomenon is not easily compensated. Therefore, the RZ signal has better characteristics than the NRZ signal when applied for long-distance transmission.

In addition, if a negative chirp signal is imposed on an optical RZ signal, the dispersion phenomenon in optical transmission can be easily obviated. Therefore, when a negative chirp signal is imposed on this RZ signal, the RZ signal can be substituted for the NRZ signal and effective long-distance transmission can be achieved.

There has been development in a variety of optical CRZ transmitters. A representative conventional optical CRZ transmitter is shown in FIG. 1.

Referring to FIG. 1, a conventional optical CRZ transmitter includes a laser diode (LD) 11 for generating an optical signal; a first amplifier 15 for receiving/amplifying NRZ data; a first optical intensity modulator 12 for modulating the NRZ data amplified by the first amplifier 15, and transmitting the modulated NRZ data to the optical signal generated from the laser diode 11; a second amplifier 16 for receiving/amplifying a clock signal; a second optical intensity modulator 13 for modulating the clock signal amplified by the second amplifier 16, and transmitting the modulated clock signal to the optical signal received from the first optical intensity modulator 12; a third amplifier 17 for amplifying a clock signal delayed to generate a chirp signal, and transmitting the delayed clock signal; and a phase modulator 14 for modulating the delayed clock signal received from the third amplifier 17, and transmitting the modulated clock signal to the optical signal received from the second optical intensity modulator 13 to create a CRZ signal.

As noted above, such a conventional optical CRZ transmitter uses two optical intensity modulators 12 and 13 and one phase modulator 14. The first optical intensity modulator 12 is adapted to impose the NRZ data on the optical signal. The second optical intensity modulator is adapted to optically convert a NRZ signal into a RZ signal using a clock signal.

Also, the phase modulator 14 is adapted to impose a chirp signal on the optical RZ signal by performing a phase modulation using a clock signal. In such an optical CRZ transmitter, it is possible to vary the chirp signal, provided that a delay value of the clock signal is properly adjusted.

In this case, provided that an optical pulse signal is transmitted via an anomalous region of an optical fiber, a delay value is properly adjusted to allow the optical pulse signal have a negative chirp signal. This is needed, because transmission characteristics of the optical pulse signal are enhanced by the negative chirp signal, which is commonly adapted to decrease a leading edge frequency of the optical pulse signal and increase a falling edge frequency thereof.

When using such a conventional optical CRZ transmitter, (1) two optical intensity modulators and one phase modulator should be employed. (2) a signal delay process should be performed to properly adjust such a chirp signal, and (3) three electric amplifiers 15, 16 and 17 are required to obtain a desired voltage at which respective modulators are operable. These requirements thereby make the overall construction of such a transmitter complicated.

Further, because of the high number of requisite components, such an optical CRZ transmitter is not cost efficient.

### SUMMARY OF THE INVENTION

Therefore, the present invention reduces or overcome many of the above problems. One object of the present invention is to provide an optical CRZ transmitter using a Mach-Zehnder (MZ) modulator, and to enable a simpler construction process and reduced production cost.

In accordance with one aspect of the present invention, an optical CRZ transmitter is provided, using a Mach-Zehnder (MZ) modulator, including a logic operation unit for receiving a NRZ data signal and a clock signal, performing a logic operation between the NRZ data signal and the clock signal, and generating electric RZ data; an amplifier for amplifying the electric RZ data generated from the logic operation unit; and a MZ modulation unit for modulating the electric RZ data amplified by the amplifier into an optical signal, and imposing a chirp signal on the optical signal by varying an input voltage of the amplified electric RZ data.

In accordance with another aspect of the present invention, an optical CRZ transmission apparatus is provided, including a logic operation unit for receiving a NRZ data signal and a clock signal, and performing a logic operation between the NRZ data signal and the clock signal to create electric RZ data; a first amplifier for amplifying a true signal received from the logic operation unit; a second amplifier for amplifying a complement signal of the true signal, received from the logic operation unit; and a MZ modulation unit for modulating the true signal and the complement signal respectively received from the first and second amplifiers into an optical signal, and imposing a chirp signal on the optical signal by varying each input voltage of the true and complement signals.

### BRIEF DESCRIPTION OF THE DRAWINGS

The present invention will be more clearly understood from the following detailed description taken in conjunction with the accompanying drawings, in which:

FIG. 1 is a schematic diagram of a conventional optical CRZ transmitter;

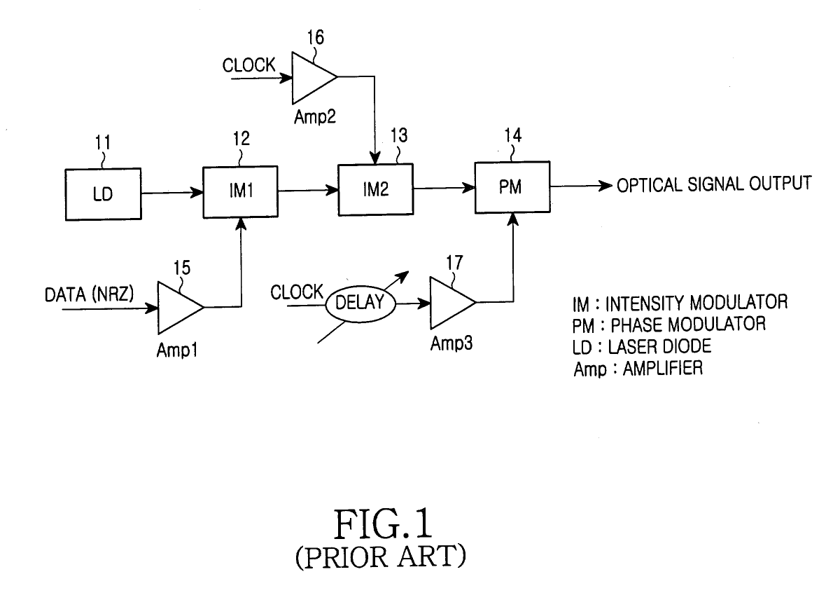

FIG. 2 is a schematic diagram of an optical CRZ transmitter using a dual-arm MZ modulator in accordance with the principles of the present invention;

FIG. 3 is a schematic diagram of an optical CRZ transmitter using a single-arm MZ modulator in accordance with the principles of the present invention;

FIG. 4 is a signal waveform diagram at each node of the optical CRZ transmitter shown in FIG. 2;

FIG. 5 is an exemplary graph illustrating a simulation result between an optical CRZ signal and a chirp signal through the use of an optical CRZ transmitter using a MZ modulator according to the present invention; and

FIG. 6 is an exemplary graph illustrating a transmission simulation result for which an optical CRZ transmitter using a MZ modulator and a conventional RZ transmitter are employed according to the present invention.

### DETAILED DESCRIPTION OF THE PREFERRED EMBODIMENTS

In the following description of the present invention, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details. Moreover, it will be recognized that certain aspects of the figures are simplified for explanation purposes and that the full system environment for the invention will comprise many known functions and configurations all of which need not be shown here. In the drawings, the same or similar elements are denoted by the same reference numerals even though they are depicted in different drawings.

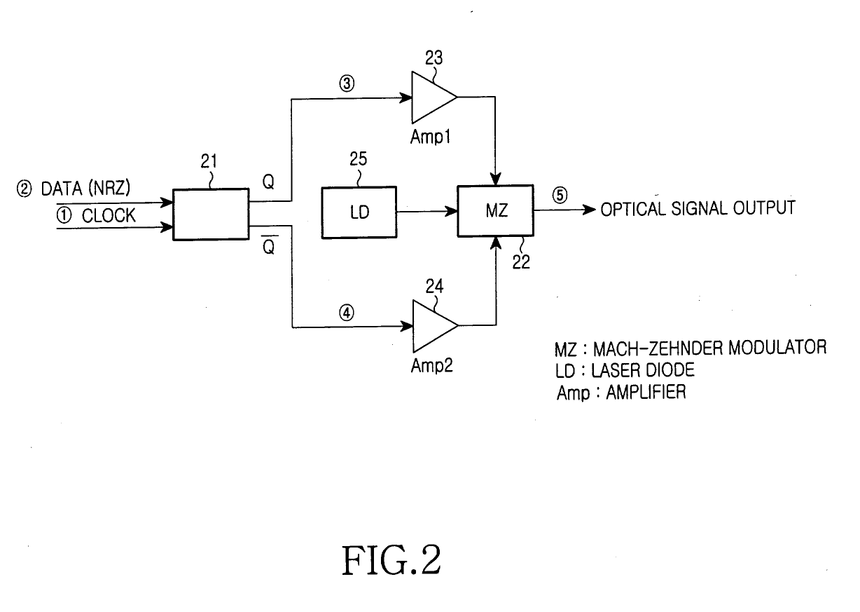

FIG. 2 is a schematic diagram of an optical CRZ transmitter using a dual-arm MZ modulator according to the principles of the present invention.

Referring to FIG. 2, an optical CRZ transmitter using a dual-arm MZ modulator includes a laser diode (LD) 25 for generating an optical signal; a logic operation unit 21 for receiving NRZ data and a clock signal, performing a logic operation on the NRZ data and the clock signal, and generating a result signal Q of the logic operation and its complement signal \overline{Q}; first and second amplifiers 23 and 24 amplify the logic operation result signal Q and its complement signal \overline{Q}; and a dual-arm MZ (Mach-Zehnder) modulator 22 for modulating the optical signal generated from the laser diode 21 with the logic operation result signal Q and its complement signal \overline{Q} amplified by first and second amplifiers 23 and 24, and imposing a chirp signal on the modulated optical signal by varying an input voltage. The above logic operation indicates a logical product (i.e., AND) operation in a preferred embodiment of the present invention.

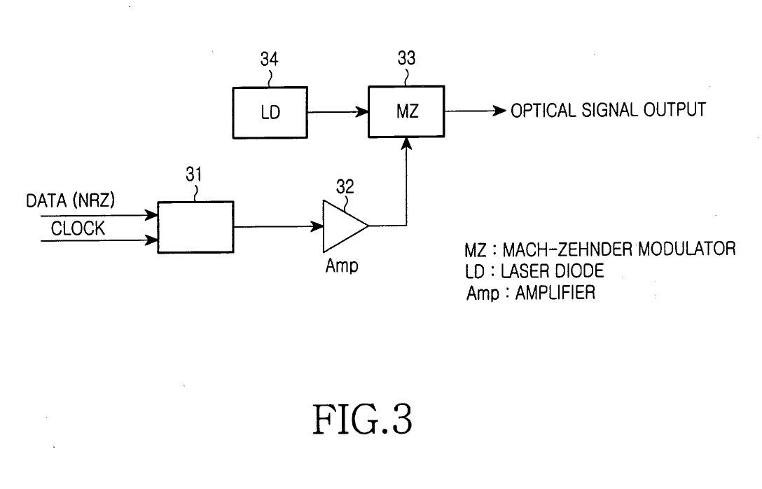

FIG. 3 is a schematic diagram of an optical CRZ transmitter using a single-arm MZ modulator according to the present invention.

Referring to FIG. 3, an optical CRZ transmitter using a single-arm MZ modulator includes a laser diode (LD) 34 for generating an optical signal; a logic operation unit 31 for receiving NRZ data and a clock signal, performing a logic operation on the NRZ data and the clock signal, and generating a result signal of the logic operation; an amplifier 32 for amplifying the logic operation result signal generated from the logic operation unit 31; and a single-arm MZ (Mach-Zehnder) modulator 33 for modulating the optical signal generated from the laser diode 34 with the logic operation result signal amplified by the amplifier 32, and imposing a chirp signal on the modulated optical signal by varying an input voltage. The above logic operation indicates a logical product (i.e., AND) operation in a preferred embodiment of the present invention.

As shown in FIGS. 2 and 3, the optical CRZ transmitter using such a MZ modulator converts electric NRZ data into electric RZ data through the use of a logic operation with a clock signal. Preferably, the logic operation converts the NRZ data into the RZ data through the use of an AND operation between a clock signal and the NRZ data.

As noted above, the optical CRZ transmitter using an MZ-modulator (1) performs an AND operation on electric NRZ data and a clock signal to create electric RZ data, (2) optically modulates the electric RZ data, and (3) imposes a chirp signal on the modulated data through the use of characteristics of the MZ modulator in an optical modulation. In contact, a conventional method (1) optically modulates electric NRZ data to be transmitted, (2) modulates the modulated electric NRZ data with a clock signal to create optical RZ data, and (3) optically modulates the optical RZ data with a delayed clock signal to impose a chirp signal on the modulated optical RZ data.

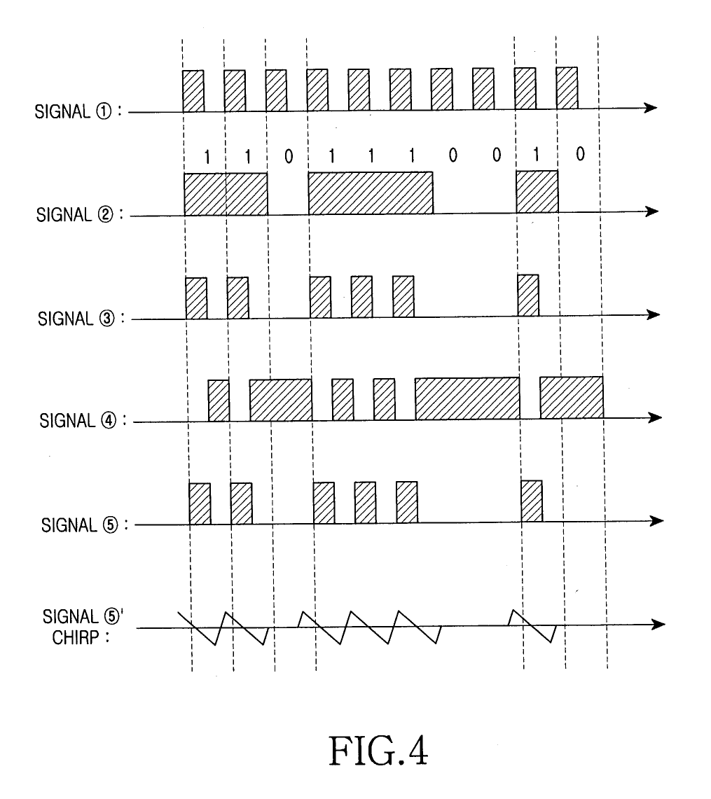

FIG. 4 is a signal waveform diagram at each position (i.e., node) of the optical CRZ transmitter shown in FIG. 2.

Referring to FIG. 4, reference character \mathring{1} denotes a clock signal, and reference character \mathring{2} denotes an arbitrary NRZ data signal, for example, ‘1101110010’. Reference character \mathring{3} denotes the result signal of an AND operation between the clock signal \mathring{1} and the NRZ data signal \mathring{2}. Reference character \mathring{4} denotes a logical inverse signal (i.e., a complement signal) of the signal \mathring{3}. This signal \mathring{4} is one of two output signals of logic operation unit 21, shown in FIG. 2.

In addition, reference character \mathring{5} denotes an optically modulated signal made by the MZ-modulator 22, and the last signal shown in FIG. 4 denotes a chirp signal of the signal \mathring{5}. Provided that two input signals being the signals \mathring{3} and \mathring{4} are properly varied, the magnitude and sign (i.e., + or −) of the chirp signal vary with the signals \mathring{3} and \mathring{4}.

There are a variety of prior art methods for controlling the MZ modulator's chirp, which are well known in the art. Thus, their detailed description will be omitted herein. A representative of such a prior art method is disclosed in Korean Patent Laid-open Publication No. 1999-6929, entitled “OPTICAL MODULATOR AND METHOD FOR MODULATING OPTICAL SIGNAL”, which is incorporated herein by reference.

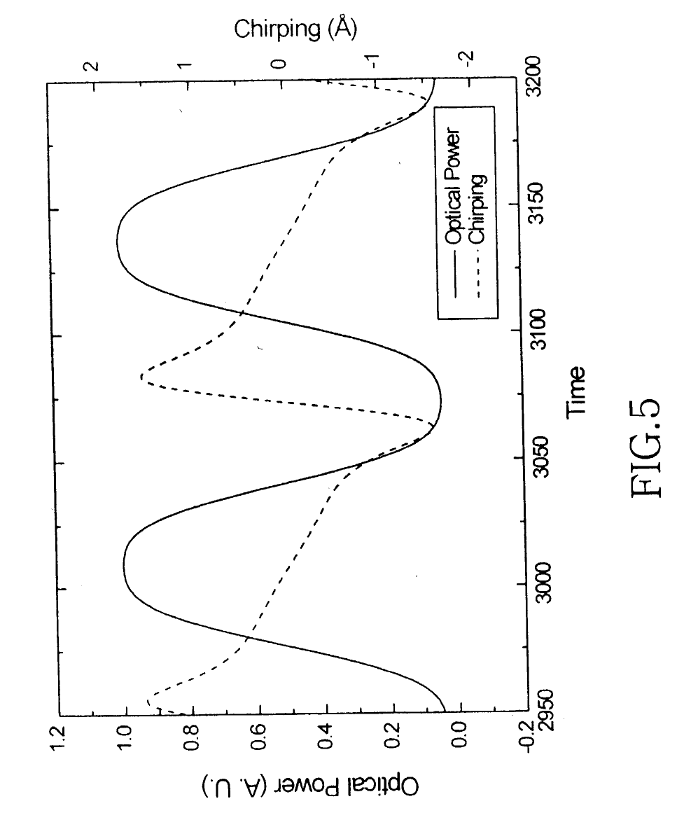

FIG. 5 is an exemplary graph illustrating a simulation result between an optical CRZ signal and a chirp signal through the use of an optical CRZ transmitter using a MZ modulator, in accordance with the principles of the present invention. Here, the X-axis indicates time, the left Y-axis indicates optical power (A.U), and the right Y-axis indicates a chirping level of a chirp signal. As shown in FIG. 5, each pulse can obtain a linear chirp.

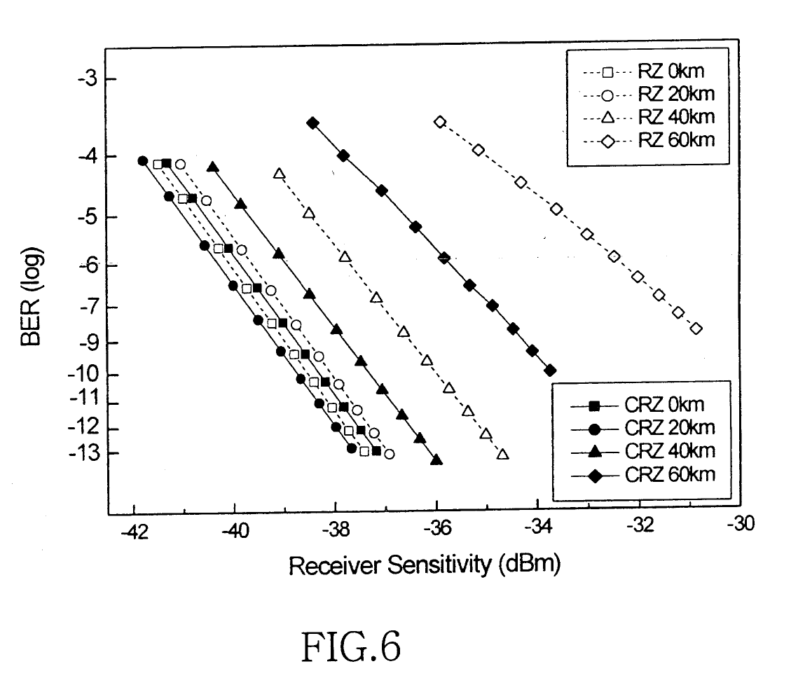

FIG. 6 is an exemplary graph illustrating a transmission simulation result for which an optical CRZ transmitter using a MZ modulator and a conventional RZ transmitter are employed. Here, the X-axis indicates receiver sensitivity and the left Y-axis indicates the Bit Error Rate (BER).

As shown in FIG. 6, a BER characteristic curve created by transmitting an RZ signal of 10 Gb/s via standard single-mode optical fibers of 0 km, 20 km, 40 km and 60 km is compared with the other BER characteristic curve created by transmitting a CRZ signal via the standard single-mode optical fibers of 0 km, 20 km, 40 km and 60 km.

Analyzing the results of the comparison, it is noted that the strength of the CRZ signal is higher than that of the RZ signal by an amount equal to the receiver sensitivity of about more than 2 dBm in long-distance transmission over 40 km. Importantly, the fact that the CRZ signal has better transmission characteristics than the RZ signal can be clearly understood with reference to the simulation result of FIG. 6.

As apparent from the above description, the optical CRZ transmitter according to the present invention creates a CRZ signal using a single logic operator and a single MZ modulator. Therefore, the present invention removes one optical intensity modulator, one phase modulator, one or two electric amplifiers, and one delay circuit from the conventional CRZ transmitter. Consequently, the overall construction is simplified and a more cost-efficient construction is provided.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical CRZ transmission apparatus, comprising:
a logic operation unit to generate electric RZ data from a received NRZ data signal and clock signal;
an amplifier to an amplify the electric RZ data; and
a MZ modulation unit to modulate the amplified electric RZ data into an optical signal and impose a chirp signal on the optical signal.

2. The apparatus as set forth in claim 1, wherein the chirp signal is imposed on the optical signal by varying an input voltage of the amplified electric RZ data.

3. The apparatus as set forth in claim 1, wherein the logic operation unit performs an AND operation between the NRZ data signal and the clock signal.

4. The apparatus as set forth in one of claims 1, 2 and 3, wherein the chirp signal is a negative chirp signal.

5. An optical CRZ transmission apparatus, comprising:
a logic operation unit to create electric RZ data from received NRZ data signal and clock signal;
a first amplifier to amplify a true signal from the logic operation unit;
a second amplifier to amplify a complement signal of the first signal, from the logic operation unit; and
a MZ modulation unit to modulate the true and complement signals respectively received from the first and second amplifiers into an optical signal, and impose a chirp signal on the optical signal by varying each input voltage of the true and complement signals.

6. The apparatus as set forth in claim 5, wherein the chirp signal is imposed on the optical signal by varying each input voltage of the true and complement signals.

7. The apparatus as set forth in claim 5, wherein the logic operation unit performs an AND operation between the NRZ data signal and the clock signal.

8. The apparatus as set forth in one of claims 5, 6 and 7, wherein the chirp signal is a negative chirp signal.

9. The apparatus as set forth in claim 5, wherein the MZ modulation unit is dual-arm Mach-Zehnder modulator.
